(19) United States
(12) Patent Application Publication
(10) Pub. No.: US 2002/0042729 A1
(43) Pub. Date: Apr. 11, 2002

(54) Specific electronic information related information providing system and specific electronic information related information providing method

(76) Inventors: Shunsuke Yajima, Nara-shi (JP); Syoichiro Yoshiura, Ikoma-gun (JP); Tsutomu Yoshimoto, Yamatotakada-shi (JP)

Correspondence Address: NIXON & VANDERHYE P.C., 8th Floor, 1100 North Glebe Road, Arlington, VA, 22201-4714, US

(21) Appl. No.: 09/971,656

(22) Filed: Oct. 9, 2001

(30) Foreign Application Priority Data
Oct. 10, 2000 (JP) P2000-309343
Aug. 2, 2001 (JP) P2000-235245

(51) Int. Cl. G06F 17/60

(52) U.S. Cl. 705/5

(57) ABSTRACT

An object of the invention is to simplify the procedure for obtaining related information related to specific electronic information such as an electronic ticket. According to the invention, an electronic ticket related information providing system comprising an electronic ticket issuing apparatus, which issues an electronic ticket as specific electronic information through an electronic transaction via a communication network, and a portable terminal, which stores ticket information corresponding to the issued electronic ticket, further includes a related information management apparatus for managing related information that is related to the ticket information and that carries, for example, information about the postponement or cancellation of an event such as a concert, transportation means to the concert site, etc., wherein when requested to provide the related information corresponding to the ticket information stored in the portable terminal, the related information management apparatus transmits the requested related information to the requesting portable terminal.

### BACKGROUND OF THE INVENTION

1. Field of the Invention

The present invention relates to a specific electronic information related information providing system in which, based on specific electronic information such as an electronic ticket obtained through an electronic transaction or the like, information related to that specific electronic information (for example, information concerning the postponement or cancellation of a concert, transportation means to the concert site, etc.) is provided to a holder of the specific electronic information.

2. Description of the Related Art

Traditionally, tickets such as concert tickets, movie tickets, air tickets, hotel tickets, etc. have been provided to purchasers in the form of specially prepared paper tickets printed on ticket paper. In recent years, however, an electronic ticketing system has been proposed that issues such tickets in an electronic form and delivers the ticket in the form of electronic data to a purchaser's portable terminal, with provisions made to treat the electronic data as an equivalent of a paper ticket at the site where it is used.

For example, Japanese Unexamined Patent Publication JP-A 2000-113238 (2000) discloses that a purchaser gets electronic money issued via a network into his or her portable telephone equipped with an IC card. Next, using the electronic money, the purchaser purchases an electronic concert ticket from a ticket center; in this case, the ticket information corresponding to the purchased electronic ticket is stored on the IC card in the form of electronic data. When the IC card with the ticket information stored thereon is inserted in a printing device installed at the concert site, seat information is printed in the print area of the IC card. The purchaser can thus enter the concert site without the need to present a ticket printed on paper.

Further, Japanese Unexamined Patent Publication JP-A 2000-90294 (2000) discloses that related information is printed simultaneously on the issued ticket (paper ticket) itself.

On the other hand, Japanese Unexamined Patent Publication JP-A 6-337883 (1994) discloses that, though it does not concern electronic ticket information, code information for identifying a resident is stored on a recording medium such as an IC card, and information concerning the resident is retrieved based on the information stored in the IC card.

When the purchaser desires to obtain various related information concerning the purchased ticket (such as information about the transportation means to the concert site, information about the postponement or cancellation of the concert, or information about the refund of the ticket), the commonly practiced method has been to telephone the concert site or the ticket center for the information. This method is also used for the electronic ticket described in JP-A 2000-113238.

However, inquiring by telephone has involved the problem that the telephone will not get through easily. Even when the telephone has finally got through, the caller has to tell the called party what information he or she wants and wait until the called party comes back with the requested information, that is, it takes time and labor to obtain the related information.

On the other hand, the method of JP-A 2000-90294 has had the problem that it is difficult to provide ever changing information since, with this method, it is only possible to print information that is definite at the time of issuing the paper ticket. Another problem has been that if there are many information items to be provided, there is a limit to the number of information items that can be provided by printing simultaneously. A further problem has been that the information that the purchaser of the ticket really wants cannot always be provided from the beginning by printing.

The method of JP-A 6-337883 has had the problem that it can only provide personal information concerning residents and cannot provide other kinds of information such as electronic ticket information or information related to the electronic ticket information, for example, map information or transportation information.

### SUMMARY OF THE INVENTION

The present invention has been devised to overcome the above enumerated problems, and an object of the invention is to provide a related information providing system comprising related information management apparatus for managing related information for specific electronic information such as electronic ticket information, and which allows desired related information to be retrieved from the related information management apparatus by using a portable terminal with the ticket information stored therein, thereby enabling the user to easily and reliably obtain the related information for the electronic ticket.

It is another object of the invention to provide a related information providing system in which a plurality of information providing terminals are provided as terminals connected to the related information management apparatus, thereby allowing the user to obtain the desired related information from the nearest information providing terminal and thus reducing the access cost required when obtaining the related information.

It is also another object of the invention to provide a related information providing system in which the related information is stored in the portable terminal so that the stored information can be brought onto the display of the portable terminal anytime, anywhere.

It is still another object of the invention to provide a related information providing system in which the information providing terminal is equipped with a display so that information useful for the ticket purchaser can be easily checked.

It is yet another object of the invention to provide a related information providing system in which the information providing terminal is configured to be able to transmit any desired portion of the related information so that the user can easily obtain only the necessary information.

It is further another object of the invention to provide a related information providing system in which a plurality of information items that can be provided are displayed on the display of the information providing terminal so that the user can obtain the necessary information by selecting it from among the displayed information items.

It is yet further object of the invention to provide a related information providing system in which when a plurality of electronic information items are found in the portable terminal, or when a plurality of related information items are found for one electronic information item, a notification prompting the user to confirm which electronic information or which related information he or she wants is produced on the display of the information providing terminal so that the user can obtain the necessary information by selecting it from among the displayed information items.

To solve the above enumerated problems, the invention provides a specific electronic information related information providing system comprising: a portable terminal in which specific electronic information is stored; and a related information management apparatus for managing related information related to the specific electronic information, and wherein, based on the specific electronic information stored in the portable terminal, the related information management apparatus transmits the related information related to the specific electronic information to an external device.

The invention also provides a specific electronic information related information providing method comprising: confirming specific electronic information stored in a portable terminal; based on the specific electronic information, collecting related information related to the specific electronic information from a related information management apparatus which manages the related information related to the specific electronic information; and transmitting the collected related information to an external device.

The invention further provides a specific electronic information related information providing system for providing related information related to specific electronic information which is held by a customer, the system managing at least the related information related to the specific electronic information and, based on the specific electronic information, collecting the related information related to the specific electronic information and providing the collected related information to the customer.

According to the invention, the related information management apparatus transmits the related information related to the specific electronic information to the external device, for example, the portable terminal of the purchaser who purchased the specific electronic information. In this way, the purchaser can easily obtain the related information related to the specific electronic information.

The invention also provides a specific electronic information related information providing system comprising: an electronic ticket issuing apparatus for issuing an electronic ticket as specific electronic information through an electronic transaction via a communication network; a portable terminal possessed by a ticket purchaser, for storing ticket information corresponding to the issued ticket; and a related information management apparatus for managing related information related to the ticket information, and wherein: based on the ticket information stored in the portable terminal, the related information management apparatus transmits the related information related to the ticket information to an external device.

In the invention, it is preferable that when a request for delivery of the related information corresponding to the ticket information stored in the portable terminal is received from the portable terminal, the related information management apparatus transmits the requested related information to the portable terminal which is an external device.

According to the invention, when the purchaser of the electronic ticket desires to obtain related information for the purchased electronic ticket, the purchaser requests the delivery of the related information using the portable terminal in which the ticket information is stored; thereupon, the related information management apparatus transmits the requested related information to the external device, for example, the portable terminal of the purchaser. In this way, the purchaser of the electronic ticket can easily obtain the related information for the purchased electronic ticket. Further, since the related information management apparatus transmits only the requested related information, a situation cannot occur where unnecessary information is delivered. That is, since the related information management apparatus delivers only the requested related information, but does not deliver irrelevant related information, the invention also offers the effect of greatly enhancing usability for the receiver of the related information.

In the invention, it is preferable that the related information management apparatus includes one or more information providing terminals as external devices, and that the request from the portable terminal for the related information is transferred to the related information management apparatus via the information providing terminal, while the requested related information is transmitted from the related information management apparatus to the information providing terminal that sent the request.

According to the invention, the transmission of the request for the related information and the reception of the related information are performed via the one information providing terminal or one of the information providing terminals installed at a plurality of locations. Accordingly, the purchaser can use the nearest information providing terminal. That is, since the purchaser need only communicate with the information providing terminal located close to his or her portable terminal, the access charge is lower than when the purchaser directly sends the related information request to and receives the related information from the related information management apparatus.

In the invention, it is preferable that the portable terminal is equipped with a display, and that the portable terminal stores the related information received from the related information management apparatus or the information providing terminal and displays the stored related information on the display.

According to the invention, the purchaser can display the related information anytime, anywhere on the display of the portable terminal used to purchase the electronic ticket.

In the invention it is preferable that the information providing terminal is equipped with a display for displaying the related information received from the related information management apparatus, the display having a larger display area than the display area of the portable terminal.

According to the invention, since the display of the information providing terminal is larger than the display of the portable terminal, it is easy to check the related information. More specifically, since the related information is displayed on the display of the information providing terminal (which is larger than the display of the portable terminal), information useful for the purchaser of the electronic ticket can be easily checked.

In the invention it is preferable that the information providing terminal is equipped with an operation part, and that, of the related information received from the related information management apparatus, the information providing terminal transmits to the external device a portion of the related information which has been specified from the operation part.

According to the invention, when the purchaser specifies the necessary portion of the related information by operating the operation part, the specified portion of the related information is transmitted to the external device. Accordingly, when the external device is the portable terminal, only the necessary related information can be obtained as information for the exclusive use of the purchaser. When the external device is a printer, only the necessary related information can be obtained in printed form. In this way, only the necessary information can be easily obtained.

In the invention the specific electronic information is rights information permitting a use of a particular facility.

According to the invention, when the specific electronic information is rights information such as a pass, a passport, a ticket, or a member's card, the purchaser can reliably obtain guide information concerning the specific facility or organization that the rights information entitles the purchaser to use. This provides a convenient means, for example, when the purchaser needs information while on a trip. Further, since the information can be obtained in advance, the purchaser can plan the schedule beforehand.

In the invention the specific electronic information is electronic money information.

According to the invention, when the specific electronic information is electronic money information, the purchaser can easily obtain from the bank, etc. various kinds of service information, such as information on the effective use of money, in relation to the electronic money information, and the purchaser can thus get information, for example, on the advantageous way to invest his or her money. On the corporation side, this can provide a useful means for securing customers.

In the invention, it is preferable that the related information management apparatus includes one or more information providing terminals as external devices, and that the related information management apparatus activates the system when the specific electronic information stored in the portable terminal is confirmed by the information providing terminal.

According to the invention, when the presence of the portable terminal with the specific electronic information stored therein is detected within the monitoring area of the information providing terminal, the system is automatically powered up; this feature serves to actively promote the use of the information providing service.

In the invention it is preferable that, when the specific electronic information stored in the portable terminal is confirmed by the information providing terminal, the related information management apparatus starts to prepare the related information to be transmitted to the external device.

According to the invention, when the presence of the portable terminal with the specific electronic information stored therein is detected within the monitoring area of the information providing terminal, the system is automatically powered up and the preparation of the related information is initiated, thus instantly starting the information providing service.

In the invention, it is preferable that when a plurality of specific electronic information items are stored in the portable terminal, an instruction is produced to select desired specific electronic information by the portable terminal, or an instruction is produced to select desired specific electronic information by the information providing terminal.

According to the invention, when there are two or more information items that can be provided, the user (the purchaser of the electronic ticket, etc.) is notified accordingly; this provides reliable means to prevent wrong information from being delivered.

In the invention it is preferable that, when there are two or more related information items that can be provided based on the specific electronic information, an instruction is produced to select desired related information by the portable terminal, or an instruction is produced to select desired related information by the information providing terminal.

According to the invention, when there are two or more related information items, the user (the purchaser of the electronic ticket, etc.) is notified accordingly; this provides reliable means to prevent wrong information from being delivered.

In the invention, it is preferable that the related information is provided from the related information management apparatus, in which frequently updated information is stored, and the information providing terminal, in which less frequently updated information is stored.

According to the invention, various kinds of information are provided, such as relatively fixed, not frequently updated information and periodically updated, that is, frequently updated information. In view of this, by collectively managing the periodically updated information in the related information management apparatus, the latest information can be provided at all times.

In the invention it is preferable that the related information is provided based on location information pertaining to the portable terminal and on location information related to the specific electronic information.

According to the invention, map information, transportation information, information about connections, etc. can be provided appropriately, based on the current location of the portable terminal and on the location information that can be determined from the specific electronic information.

In the invention it is preferable that the specific electronic information related information providing system comprises a printing unit as an external unit for printing out the related information provided from the related information management apparatus.

According to the invention, by printing out the related information, the information can be provided by means of a medium; this feature is useful, for example, when the purchaser uses the information providing service while on a trip.

### BRIEF DESCRIPTION OF THE DRAWINGS

Other and further objects, features, and advantages of the invention will be more explicit from the following detailed description taken with reference to the drawings wherein:

FIG. 1 is a block diagram showing the electrical configuration of a first embodiment where a specific electronic information related information providing system according to the present invention is applied to an electronic ticket related information providing system;

FIG. 2 is a block diagram showing the electrical configuration of a second embodiment; and

FIG. 3 is a flow chart illustrating a related information providing procedure for the specific electronic information related information providing system according to the present invention.

### DETAILED DESCRIPTION OF THE PREFERRED EMBODIMENTS

Now referring to the drawings, preferred embodiments of the invention are described below.

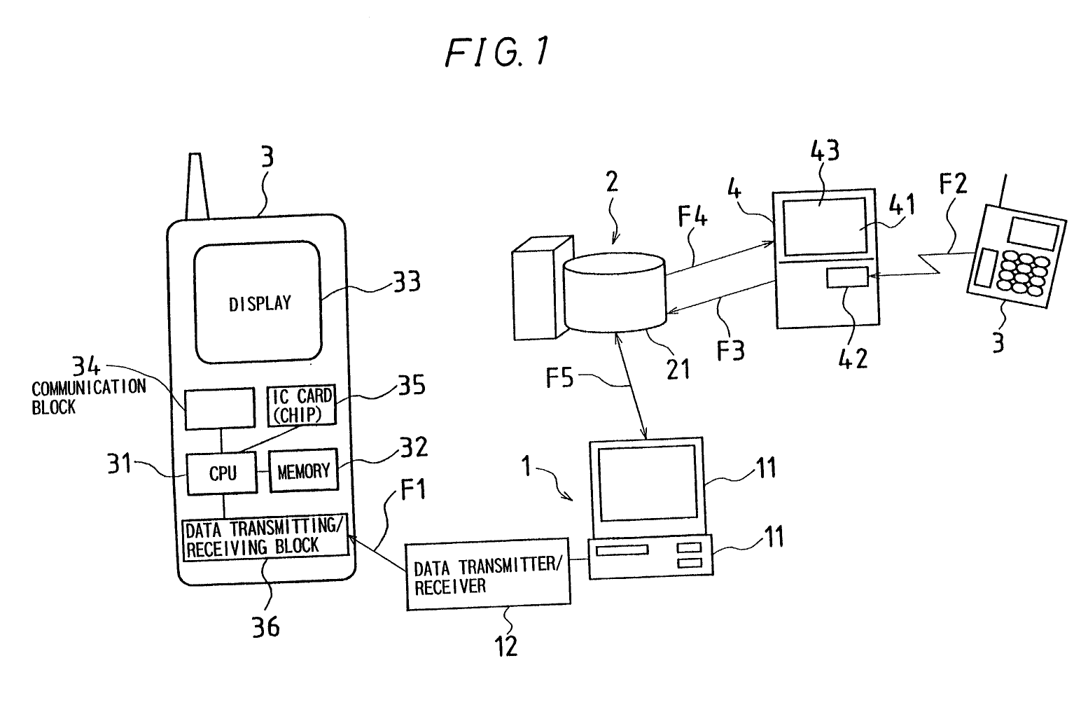

FIG. 1 is a block diagram showing the electrical configuration of a first embodiment where a specific electronic information related information providing system according to the present invention is applied to an electronic ticket related information providing system.

In FIG. 1, this embodiment roughly comprises an electronic ticket issuing apparatus 1 installed at an electronic ticket sales center or the like, a portable terminal (for example, a portable telephone) 3 that the purchaser of an electronic ticket carries, a related information management apparatus 2 installed at an electronic ticket information center or the like, and an information providing terminal 4 connected to the related information management apparatus 2.

Actually, two or more information providing terminals 4 are provided, but in the figure, only one apparatus is shown and the other apparatuses are not shown here. The electronic ticket issuing apparatus 1, the related information management apparatus 2, the portable terminal 3, and the information providing terminal 4 are connected by a communication network using a leased line, public line, or the like. Only one electronic ticket issuing apparatus 1 is shown here, but actually, a plurality of ticket issuing apparatuses are provided in the system.

More specifically, the electronic ticket issuing apparatus 1 is an apparatus capable of issuing tickets such as concert tickets or movie tickets for sale in the form of electronic tickets. For this purpose, the electronic ticket issuing apparatus 1 comprises an information processor 11 constructed from a workstation or the like, and a data transmitter/receiver 12 constructed from a modem or the like.

The related information management apparatus 2 manages ticket information concerning the various kinds of electronic tickets that the electronic ticket issuing apparatus 1 issues. For this purpose, the related information management apparatus 2 stores ticket information essential to electronic tickets, such as the dates of concerts, concert names, concert sites, etc. The related information management apparatus 2 also stores related information for corresponding ticket information. For this purpose, the related information management apparatus 2 is equipped with a data base unit 21 whose main component is a hard disk.

Examples of the related information stored in the related information management apparatus 2 include guide information such as transportation means to the concert site, the timetable of transportation means, the availability of parking space, etc., information about the postponement or cancellation of the concert or a change in the opening time, and information about the refund of the electronic ticket in the event of the cancellation of the concert. That is, the related information contains information that the purchaser of the electronic ticket desires to get.

The portable terminal 3 is typically a portable telephone, and has such functions as storing related information and displaying the stored related information. For this purpose, the portable terminal 3 is equipped with a CPU 31 and a memory 32. The portable terminal 3 further includes a display 33 constructed from a liquid crystal panel or the like, a communication block 34 for performing communications over a car telephone/portable telephone line, and a data transmitting/receiving block 36 constructed from a modem or the like.

The portable terminal 3 is also equipped with an IC card 35 for storing ticket information concerning an electronic ticket; at the site of the event, etc., the IC card 35 serves as a ticket.

The information providing terminal 4 functions as a terminal subservient to the related information management apparatus 2; in an actual system, such information providing terminals 4 are installed at a plurality of locations. That is, the information providing terminals 4 are installed not only at the electronic ticket sales center where the electronic ticket issuing apparatus 1 is installed, but also at convenience stores and other locations.

When there is a request from the portable terminal 3 for delivery of related information, the information providing terminal 4 transmits the ticket information received from the portable terminal 3 to the related information management apparatus 2. Next, when the related information corresponding to the transmitted ticket information is received from the related information management apparatus 2, the information providing terminal 4 displays the received related information. For this purpose, the information providing terminal 4 comprises a display 41, an interface unit 42, and an operation part 43 (such as a touch panel provided on the display 41). The display 41 has a larger display area than the display 33 of the portable terminal 3.

The communication network will be described. The line (F1) connecting the portable telephone 3 directly to the electronic ticket issuing apparatus 1 and the line (F2) connecting the portable telephone 3 to the information providing terminal 4 are car telephone/portable telephone lines. On the other hand, the line (F5) connecting between the electronic ticket issuing apparatus 1 and the related information management apparatus 2 and the lines (F3 and F4) connecting between the related information management apparatus 2 and the information providing terminal 4 are high-speed communication lines. These lines are constructed by including the Internet, the provider's servers, etc.

A description will be given of how the related information is provided in the embodiment of the above-described configuration.

First, the user of the portable terminal 3 purchases an electronic ticket for an event such as a concert from the electronic ticket issuing apparatus 1. In this case, ticket information concerning the purchased electronic ticket is loaded in the form of electronic data into the IC card 35 in the purchaser's portable terminal 3 (the information flow at this time is shown by F1).

At this time, the electronic ticket issuing apparatus 1 receives from the related information management apparatus 2 the kind of electronic ticket that the user desires to purchase and information indicating how many electronic tickets remain available for sale. When the sale of the electronic ticket is completed, the result of the sale is transmitted to the related information management apparatus 2 (the information flow at this time is shown by F5).

There are two methods of purchasing the electronic ticket: in one method, the purchaser purchases the electronic ticket by visiting the electronic ticket sales center in person where the electronic ticket issuing apparatus 1 is installed, and in the other, the purchaser purchases the electronic ticket from the electronic ticket issuing apparatus 1 via the communication network by using an electronic money settlement service.

The present embodiment is applicable to the electronic ticket purchased by either of the above methods. A detailed description will be given below.

When the purchaser desires to obtain related information for the purchased electronic ticket, the purchaser visits the nearest location where the information providing terminal 4 is installed. The purchaser then operates the portable terminal 3 to enter a request for related information. To accomplish this operation, the purchaser holds the portable terminal 3 over the information providing terminal 4 (that is, brings the former close to the latter), or the purchaser carrying the portable terminal 3 just stands in front of the information providing terminal 4, whereupon the terminals 3 and 4 become ready to communicate with each other using a communication protocol. It is preferable that the communication can be performed wirelessly by using Bluetooth or an infrared (Ir) wireless link.

With the above operation, the ticket information stored in the IC card 35 in the portable terminal 3 is transmitted to the information providing terminal 4 (the information flow at this time is shown by F2). The information providing terminal 4 then sends a query to the related information management apparatus 2 for information related to the received ticket information (the information flow at this time is shown by F3).

The related information management apparatus 2 retrieves the related information for that ticket information by searching the data base unit 21, and transmits only the retrieved related information to the information providing terminal 4 (the information flow at this time is shown by F4). The information providing terminal 4 that received the related information displays the received related information on the display 41. The purchaser of the electronic ticket can thus obtain the information related to the purchased electronic ticket.

In the above embodiment, the related information request and the related information have been described as being transferred via the information providing terminal 4, but in an alternative method, the portable terminal 3 can receive the requested related information directly from the related information management apparatus 2 by transferring data directly between them without the intervention of the information providing terminal 4.

However, when receiving the related information directly from the related information management apparatus 2, since the display area of the display 33 on the portable terminal 3 is small, the display screen has to be scrolled several times to check the received related information, causing inconvenience to the user. It is therefore preferable to receive the related information via the information providing terminal 4 because it then becomes easier to check the received related information. Another advantage is that the access charge required to access the related information management apparatus 2 is lower when the information providing terminal 4 is used because it is connected to the related information management apparatus 2 via a leased line.

Further, to request the delivery of related information, the user need only perform a request operation on the portable terminal 3 (this can be accomplished, for example, by just bringing the portable terminal 3 close to the information providing terminal 4 or by operating two or three keys on the portable terminal 3); then, the ticket information concerning the electronic ticket is, so to speak, automatically transmitted from the portable terminal 3 to the information providing terminal 4. In this way, the ticket information concerning the purchased electronic ticket can be transmitted to the related information management apparatus 2 by a simple operation.

Based on the received ticket information, the related information management apparatus 2 searches the data base unit 21, retrieves only the pertinent related information, and delivers the retrieved information. This greatly enhances the usability of the information providing service because irrelevant ticket related information is not transmitted to the receiver but only the requested related information is transmitted.

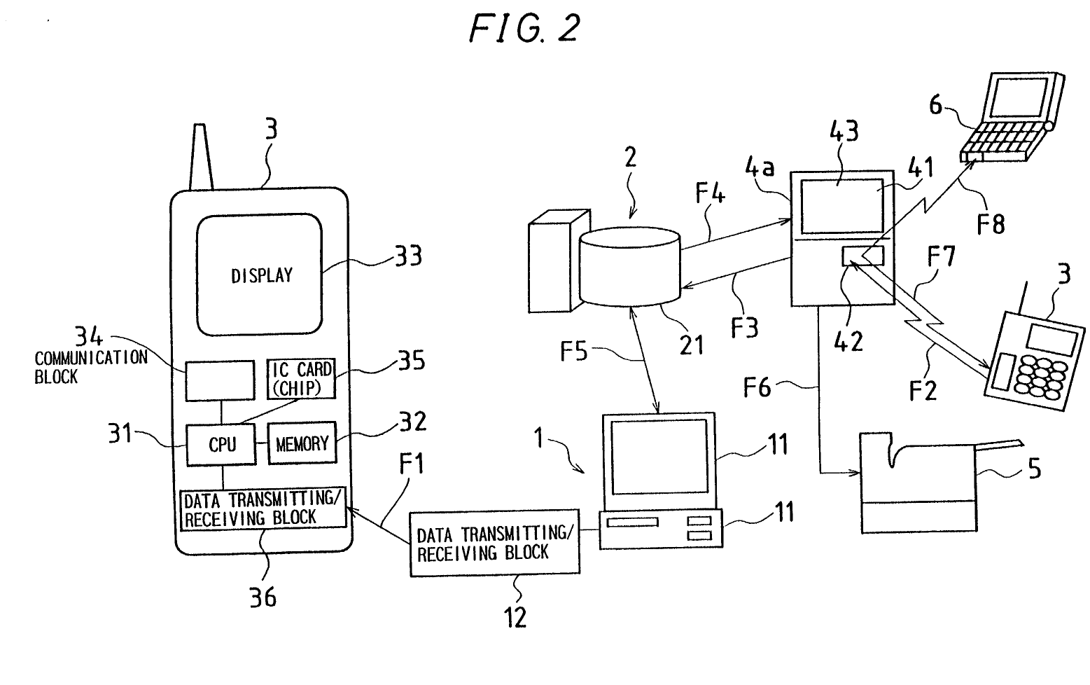

FIG. 2 is a block diagram showing the electrical configuration of a second embodiment of a specific electronic information related information providing system according to the present invention.

The second embodiment of the invention is the same in configuration as the first embodiment of the invention, the only difference being in the devices connected to the information providing terminal 4a. Therefore, the same devices or apparatuses as those in the first embodiment are designated by the same reference numerals as those in FIG. 1, and will not be described in detail here.

The information providing terminal 4a in this embodiment, as in the first embodiment, displays the related information received from the related information management apparatus 2 on the display 41.

When requested by the purchaser, the received related information can be transferred into the purchaser's portable terminal 3 (the information flow at this time is shown by F7) It is also possible to transfer the received related information into a PDA (Personal Digital Assistant) 6 (the information flow at this time is shown by F8). If needed, the received related information can be output to an output device 5 such as a printer (the information flow at this time is shown by F6).

Furthermore, the purchaser of the electronic ticket can select (for example, by operating the touch panel 43 on the display 41) all of the received related information or a desired portion of it as the related information to be transferred into the portable terminal 3 or PDA 6 or the output device 5.

The transfer of the related information from the information providing terminal 4a to the portable terminal 3 or PDA 6 is performed using, for example, an infrared communication link or a short distance wireless link.

Since the second embodiment of the invention is configured as described above, the purchaser of the electronic ticket can easily select the necessary portion of the related information received from the related information management apparatus 2 and load only the necessary information into the portable terminal 3 or PDA 6 as information for their own use.

Once the related information is loaded, the loaded related information can be brought onto the display of the portable terminal 3 or PDA 6. Accordingly, the purchaser can check the related information anytime, anywhere. Since the ticket information can also be displayed on the display, the ticket information can be checked along with the related information.

When the related information is printed out by the output device 5, the necessary related information can be obtained in printed form.

In the above description, the information providing terminal 4a and the output device (printer) 5 have been described as being separate systems, but they can be combined as a single terminal device; furthermore, the system can also be implemented even in an environment where the output device (printer) 5 directly communicates with the portable terminal 3.

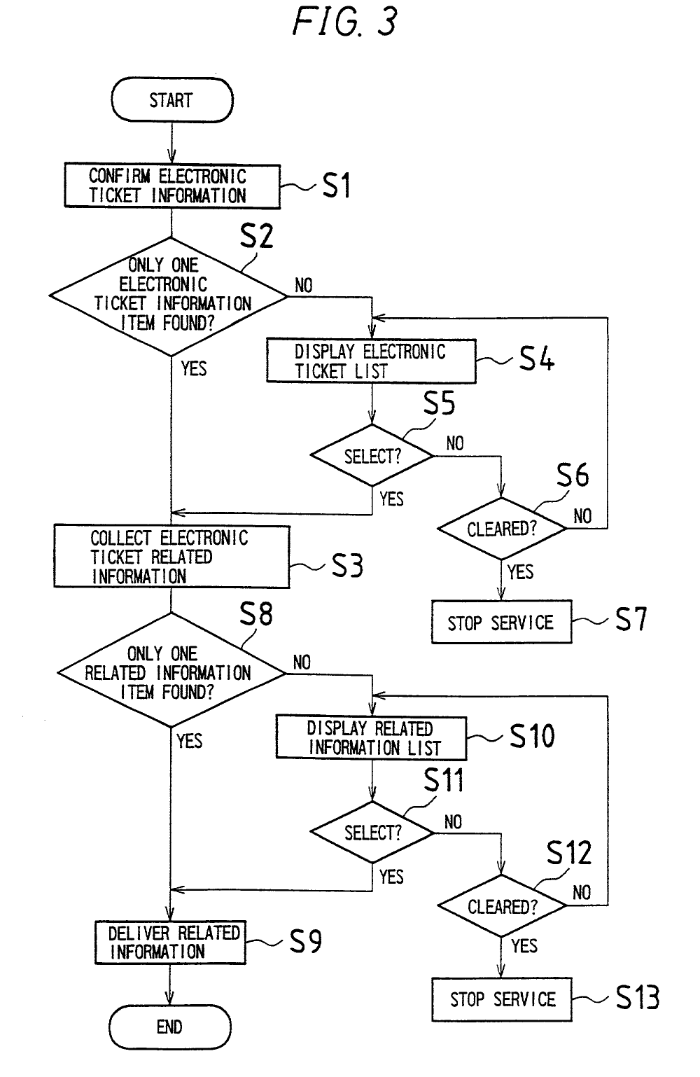

FIG. 3 is a flow chart illustrating a related information providing procedure for the related information providing system of FIG. 1 or 2. The related information providing procedure performed by the related information providing system of the invention will be describe below in further detail with reference to the flow chart.

As earlier described, when the operation of the system is initiated by operating the portable terminal 3 or the information providing terminal 4, 4a, and the specific electronic information (electronic ticket information) stored in the portable terminal 3 is confirmed by the information providing terminal 4, 4a (step S1), the information providing terminal 4, 4a first checks whether there are two or more specific electronic information items (electronic ticket information items) (step S2). If there is only one (the answer in step S2 is Yes), then the information related to the confirmed electronic information (electronic ticket information) is collected from the related information management apparatus 2 (S3). The collection of the related information is carried out in a series of steps which comprises querying the related information management apparatus 2 for the information related to the electronic information received by the information providing terminal 4, 4a, retrieving the information related to the electronic information from the data base unit 21 in the related information management apparatus 2, and transmitting only the retrieved related information to the information providing terminal.

On the other hand, if the existence of two or more specific electronic information items (electronic ticket information item) is confirmed by the information providing terminal 4, 4a (the answer in step S2 is No), the confirmed electronic information (electronic ticket information) is displayed in the form of a list on an operation screen, for example, on the display 41 of the information providing terminal 4, 4a, prompting the purchaser to select the desired information item (step S4). When the purchaser, in response to the prompting, selects the desired information item from the list by operating the operation part 43 of the information providing terminal 4, 4a (the answer in step S5 is Yes), the information providing terminal 4, 4a collects the information related to the selected electronic information (electronic ticket information) (step S3). On the other hand, if the “clear” key on the operation screen is operated because there is no desired electronic information in the displayed information list (the answer in step S5 is No and the answer in step S6 is Yes), the information providing service of the system is stopped (step S7).

Next, the process after the information related to the selected electronic information (electronic ticket information) has been collected, that is, the process after step S3, will be described below.

First, the information providing terminal 4, 4a checks whether two or more related information items have been collected for the selected electronic information (electronic ticket information) (step S8). If there is only one related information item that can be provided (the answer in step S8 is Yes), then that related information is delivered (step S9).

On the other hand, if there are two or more related information items that can be provided (the answer in step S8 is No), then the related information items that can be provided are displayed in the form of a list on the operation screen, that is, on the display 41 of the information providing terminal 4, 4a, prompting the purchaser to select the desired related information from the list (step S10). When the purchaser selects the desired related information from the list in accordance with the prompting (the answer in step S11 is Yes), the selected related information is delivered (step S9). On the other hand, if the “clear” key on the operation screen is operated because there is no desired related information in the displayed information list (the answer in step S11 is No and the answer in step S12 is Yes), the information providing service of the system is stopped (step S13).

The related information delivered in step S9 can be displayed on the operation screen, that is, on the display 41 of the information providing terminal 4, 4a, or can be recorded (printed out) directly on paper by the printer 5. It is also possible to transfer the related information as data into the purchaser's portable terminal 3. In steps S4 and S10, the display of the list has been described as being produced on the display 41 of the information providing terminal 4, 4a, but instead, the list may be displayed on the display 33 of the portable terminal 3. In that case, the selection may be made by operating the portable terminal 3.

The process flow of the specific electronic information related information providing service has been described above.

Next, the specific electronic information and the related information provided in relation to it will be described.

The specific electronic information refers, for example, to rights information entitling the holder to admission to a concert, movie theater, event, amusement park, etc. or to use a facility such as a hotel, or rights information entitling the holder to transportation such as an airplane, national or private railway, bus, etc. Rights information entitling the holder to use such service repeatedly, such as a season pass, coupon ticket, prepaid card, club membership, etc., can also be included in the category of specific electronic information.

The related information provided in relation to such electronic information (rights information) differs according to the kind of the electronic information; in the case of the rights information entitling the holder to admission to a concert, movie theater, event, amusement park, etc. or to use a facility such as a hotel, examples of the related information include information about the route to the destination, transportation information, pamphlet information, information about the opening time, etc., information about the event time, an event site guide, and information about the waiting time.

In the case of the rights information entitling the holder to transportation such as an airplane, national or private railway, bus, etc., examples of the related information include a timetable, information about local transportation, accommodations information, information about connections, and sightseeing guide information.

The related information for a season pass may include a timetable, information about connections, etc., and the related information for a sport event ticket may include information about athletes, an event site guide, history of past games, etc. In the case of electronic lottery information, examples of the related information include information about winning numbers (the purchaser can check the number of his or her electronically purchased electronic lottery ticket directly against the winning number list), announcement of winning numbers, information about lottery ticket sales dates, and other lottery guide information. Furthermore, in the case of rights information used in an environment of an amusement facility (for example, a horse race betting ticket), information before a race, race result information, etc. can be provided as the related information. In this case also, the purchaser can check his or her electronically purchased electronic betting ticket information directly against the winning horse list by holding the portable terminal 3 over the information providing terminal 4, 4a.

The related information for membership rights information such as training gym membership rights information may include gym activity information, facility information, personal management information (such as gym training records and physical strength and fitness test information), etc. The related information for membership rights information such as supermarket membership rights information may include bargain sale information (advertising information), and in the case of newspaper/magazine subscription rights information, articles, etc. can be provided as the related information. Further, for golf membership rights information, golf course information, instructions information, etc. can be provided as the related information.

Next, the relationship between the information providing terminal 4, 4a and the portable terminal 3 will be explained.

The information providing terminal 4, 4a is constantly monitoring whether any portable terminal 3 with specific electronic information stored therein exists within its monitoring area. If any portable terminal 3 carrying specific electronic information is detected, the system is powered up by responding to that electronic information, collects information, and instantly displays the collected information on the display of the information providing terminal 4, 4a. For example, the information providing terminal 4, 4a is constantly emitting a special radio wave. When this radio wave is received by the portable terminal 3, the electronic information stored therein is read out and transmitted to the information providing terminal 4, 4a by a radio wave. The system can also be powered up to initiate the service by operating the operation part of the information providing terminal 4, 4a. It is also possible to turn on the information providing terminal 4, 4a by operating the portable terminal 3. For example, access can be made to the information providing terminal 4, 4a from the portable terminal 3 by performing a prescribed operation. In the present invention, the above series of operations is referred to as the “system power up”, “system activation”, or “system operation”. Based on the electronic information (electronic ticket information) stored in the portable terminal 3, the retrieval (collection) of new related information for the electronic information is initiated.

When there are two or more electronic information items (electronic ticket information items) stored in the portable terminal 3, the detected electronic information items (electronic ticket information items) are displayed on the display screen of the information providing terminal 4, 4a, prompting the purchaser to select the information item for which he or she wants the related information, as earlier described.

Further, in the case of the information that can be provided, the preparation of the related information to be transmitted is started when the existence of the electronic information (electronic ticket information) stored in the portable terminal 3 is confirmed and, if there are two or more information items that can be provided, the information items that can be provided are displayed on the display screen of the information providing terminal 4, 4a, prompting the user to select the desired information item.

In the above embodiment, the related information management apparatus 2 has been described as the source of the related information to be provided to the purchaser, that is, the appropriate related information is retrieved (collected) from the related information management apparatus 2 and provided to the purchaser; alternatively, the information providing terminal 4, 4a itself may be configured to store the appropriate related information that can be provided to the user.

It is also possible to provide the appropriate information by selecting it from among the information stored in the related information management apparatus 2 and the information stored in the information providing terminal 4, 4a. Various kinds of information are provided, such as relatively fixed, not frequently updated information and periodically updated, that is, frequently updated information. Therefore, by making provisions so that relatively fixed, not frequently updated information is stored and managed in the information providing terminal 4, 4a, and so that periodically updated information, that is, frequently updated information, is collectively managed in the related information management apparatus 2, the latest information can be provided at all times.

Of the information to be provided from the information providing terminal 4, 4a, map information, transportation information, sightseeing information, etc. are often information specific to the local district. Therefore, based on the location information (address, latitude/longitude, name of facility, etc.) determined from the electronic information (electronic ticket information) stored in the portable terminal 3 and on the information concerning the location of the information providing terminal 4, 4a, information such as route guide or sightseeing guide that matches the location information can be provided.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A specific electronic information related information providing system comprising:
a portable terminal in which specific electronic information is stored; and
a related information management apparatus for managing related information related to the specific electronic information,
wherein, based on the specific electronic information stored in the portable terminal, the related information management apparatus transmits the related information related to the specific electronic information to an external device.

2. A specific electronic information related information providing system comprising:
an electronic ticket issuing apparatus for issuing an electronic ticket as specific electronic information through an electronic transaction via a communication network;
a portable terminal possessed by a ticket purchaser, for storing ticket information corresponding to the issued ticket; and
a related information management apparatus for managing related information related to the ticket information,
wherein, based on the ticket information stored in the portable terminal, the related information management apparatus transmits the related information related to the ticket information to an external device.

3. The specific electronic information related information providing system of claim 2, wherein when a request for delivery of the related information corresponding to the ticket information stored in the portable terminal is received from the portable terminal, the related information management apparatus transmits the requested related information to the portable terminal which is an external device.

4. The specific electronic information related information providing system of claim 2, wherein the related information management apparatus includes one or more information providing terminals as external devices, and wherein a request from the portable terminal for the related information is transferred to the related information management apparatus via the information providing terminal, while the requested related information is transmitted from the related information management apparatus to the information providing terminal that sent the request.

5. The specific electronic information related information providing system of claim 2, wherein the portable terminal is equipped with a display, and wherein the portable terminal stores the related information received from the related information management apparatus or the information providing terminal and displays the stored related information on the display.

6. The specific electronic information related information providing system of claim 4, wherein the portable terminal is equipped with a display, and wherein the portable terminal stores the related information received from the related information management apparatus or the information providing terminal and displays the stored related information on the display.

7. The specific electronic information related information providing system of claim 6, wherein the information providing terminal is equipped with a display for displaying the related information received from the related information management apparatus, the display having a larger display area than a display area of the portable terminal.

8. The specific electronic information related information providing system of claim 4, wherein the information providing terminal is equipped with an operation part, and that, of the related information received from the related information management apparatus, the information providing terminal transmits to the external device a portion of the related information which has been specified from the operation part.

9. The specific electronic information related information providing system of claim 1, wherein the specific electronic information is rights information permitting a use of a particular facility.

10. The specific electronic information related information providing system of claim 1, wherein the specific electronic information is electronic money information.

11. The specific electronic information related information providing system of claim 1, wherein the related information management apparatus includes one or more information providing terminals as external devices, and the related information management apparatus activates the system when the specific electronic information stored in the portable terminal is confirmed by the information providing terminal.

12. The specific electronic information related information providing system of claim 11, wherein when the specific electronic information stored in the portable terminal is confirmed by the information providing terminal, the related information management apparatus starts to prepare the related information to be transmitted to the external device.

13. The specific electronic information related information providing system of claim 1, wherein when a plurality of specific electronic information items are stored in the portable terminal, an instruction is produced to select desired specific electronic information by the portable terminal.

14. The specific electronic information related information providing system of claim 11, wherein when a plurality of specific electronic information items are stored in the portable terminal, an instruction is produced to select desired specific electronic information by the information providing terminal.

15. The specific electronic information related information providing system of claim 1, wherein when there are two or more related information items that can be provided based on the specific electronic information, an instruction is produced to select desired related information by the portable terminal.

16. The specific electronic information related information providing system of claim 11, wherein when there are two or more related information items that can be provided based on the specific electronic information, an instruction is produced to select desired related information by the information providing terminal.

17. The specific electronic information related information providing system of claim 11, wherein the related information is provided from the related information management apparatus, in which frequently updated information is stored, and the information providing terminal, in which less frequently updated information is stored.

18. The specific electronic information related information providing system of claim 1, wherein the related information is provided based on location information pertaining to the portable terminal and on location information related to the specific electronic information.

19. The specific electronic information related information providing system of claim 1, further comprising:
a printing unit as an external unit for printing out the related information provided from the related information management apparatus.

20. A specific electronic information related information providing method comprising:
confirming specific electronic information stored in a portable terminal;
based on the specific electronic information, collecting related information related to the specific electronic information from a related information management apparatus for managing the related information related to the specific electronic information; and
transmitting the collected related information to an external device.

21. A specific electronic information related information providing system for providing related information related to specific electronic information which is held by a customer, the system managing at least the related information related to the specific electronic information and, based on the specific electronic information, collecting the related information related to the specific electronic information and providing the collected related information to the customer.
